(19) United States
(12) Patent Application Publication
(10) Pub. No.: US 2012/0118602 A1
(43) Pub. Date: May 17, 2012

(54) ELECTRICAL DISTRIBUTION PANEL ENCLOSURE ACCESS DOOR

(75) Inventor: Scot Eugene REMMERT, Mt. Pulaski, IL (US)

(73) Assignee: EATON CORPORATION, Cleveland, OH (US)

(21) Appl. No.: 12/944,293

(22) Filed: Nov. 11, 2010

(51) Int. Cl. H01H 9/02

(52) U.S. Cl. 174/53

(57) ABSTRACT

Apparatus and methods for providing an electrical distribution panel enclosure including a front door and an access door. The enclosure has a rear wall having side walls, a top wall, and a bottom wall extending from the rear wall to define a front opening to an interior of the enclosure. The enclosure houses a plurality of electrical devices. The front door is coupled to the enclosure to cover the front opening. The front door also includes an access opening that provides access to less than all of the plurality of the electrical devices when the front door is closed. The access door is coupled to the front door and covers the access opening. The access door moves with respect to the front door to provide access to less than all of the plurality of electrical devices.

### BACKGROUND

Electrical distribution panel enclosures or load centers are used widely in residential and commercial applications. Electrical distribution panel enclosures typically comprise a box made of folded sheet metal and a separate cover or door fastened to the front of the box. The electrical distribution panel enclosure houses electrical devices, such as circuit breakers and electrical receptacles. Electrical distribution enclosure panels are used in public environments (e.g. trade shows) to provide power to individuals in the public environment. The individuals may require power (e.g. for a trade show booth), but the individuals may not require access to other devices in the electrical distribution panel enclosure.

### SUMMARY

An electrical distribution panel enclosure is provided that includes a rear wall having side walls, a top wall, and a bottom wall that extend outward from the rear wall. The side walls, the top wall, and the bottom wall define a front opening to an interior of the electrical distribution panel enclosure. The electrical distribution panel enclosure houses a plurality of electrical devices. The plurality of electrical devices may include at least one type of the electrical device, the types including electrical receptacles, circuit breakers, Category-5 jacks, cable jacks, phone jacks, and electrical switches.

The electrical distribution panel enclosure includes a front door. The front door includes an interior face located opposite the rear wall and an exterior face located on the exterior of the electrical distribution panel enclosure. The front door includes an access opening that provides access to less than all of the plurality of the electrical devices when the front door is closed. The front door may be attached at a side wall of the electrical distribution panel enclosure. The front door may be attached to the electrical distribution panel enclosure with at least one hinge.

An access door is coupled to the front door to cover the access opening. The access door is moveable with respect to the front door to provide access to less than all of the plurality of the electrical devices. The access door may be attached to the front door at a top of the access opening with at least one hinge. In one embodiment, the access door is securable from the interior of the electrical distribution panel enclosure. The access door is independently operable with respect to the front door.

### BRIEF DESCRIPTION OF THE DRAWINGS

The accompanying drawings, which are incorporated in and constitute a part of the specification, illustrate various example systems, methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is a front view of an example embodiment of an electrical distribution panel enclosure with an access door.

FIG. 2A is a front cutaway view of the electrical distribution panel enclosure of FIG. 1.

FIG. 2B is a close up front cutaway view of the electrical distribution panel enclosure of FIG. 1.

FIG. 3A is a side cutaway view of the electrical distribution panel enclosure of FIG. 1.

FIG. 3B is a side cutaway view of the electrical distribution panel enclosure of FIG. 1.

FIG. 3C is a front cutaway view of the electrical distribution panel enclosure of FIG. 1.

FIG. 4 is a front cutaway view of another example embodiment of an electrical distribution panel enclosure with an access door.

FIG. 5 is a side cutaway view of the electrical distribution panel enclosure of FIG. 4.

### DETAILED DESCRIPTION

Typical electrical distribution panel enclosures comprise a single cover or door, the cover or door must remain open to provide individuals access, exposing all of the power devices even if access to only a subset of the electrical devices is required. In some circumstances it is undesirable to leave the cover or door of an electrical distribution panel enclosure open merely to provide individuals access to a subset of the electrical devices that the electrical distribution panel enclosure houses. For example, leaving the cover or door open may be necessary to allow an individual access to a subset of electrical devices (e.g., power receptacles) that the individual is authorized to use. However, leaving the cover or door open would also allow the individual access to other electrical devices (e.g., circuit breakers) that the individual is not authorized to use. Leaving the cover or door open may also expose all of the electrical devices in the electrical distribution panel enclosure to the elements (e.g., high winds, rain, and electrical storms).

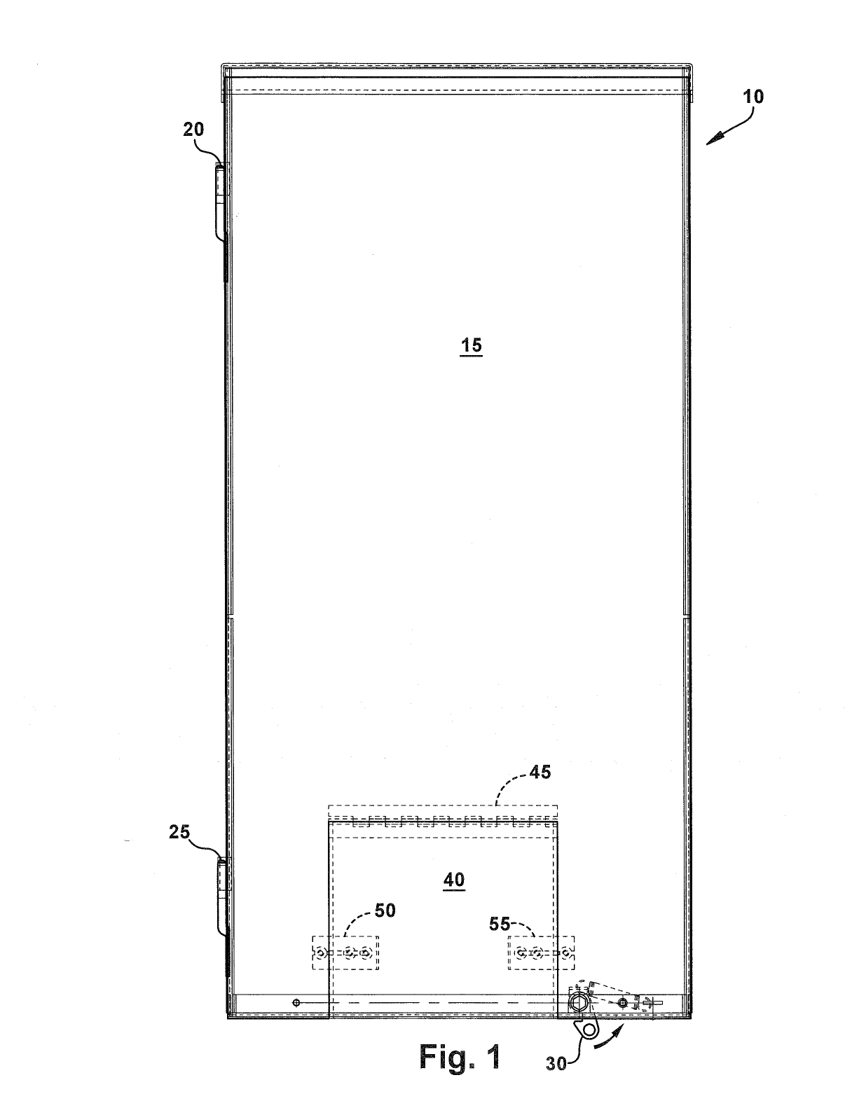

Referring to FIG. 1, an example embodiment of an electrical distribution panel enclosure 10 that includes an access door 40 is illustrated. The electrical distribution panel enclosure 10 includes a front door 15 attached to the electrical distribution panel enclosure 10. In the embodiment illustrated in FIG. 1, the front door 15 is attached to the enclosure 10 with front door hinges 20 and 25.

The front door 15 may be secured to the electrical distribution panel enclosure 10 in a closed fashion with a fastening mechanism 30 (e.g., latch). Additionally, the front door 15 can be further secured. Fastening mechanism 30 may be locked with additional implementations (e.g., padlocked, dial lock). This provides the electrical distribution panel enclosure 10 with an added level of security.

The access door 40 is attached to the front door 15 with an access door hinge 45. The access door hinge 45 attaches the access door 40 to the front door 15 at the top of the access door 40. Alternatively, the access door 40 can be attached to the front door 15 at the side of the access door 40. The access door 40 can be secured to the front door 15 from within the interior of the electrical distribution panel 10 with latching mechanisms 50 and 55. Therefore, when the access door 40 is closed and secured to the front door 15, the access door 40 cannot be opened until the front door 15 is opened so that the latching mechanisms 50 and 55 can be unfastened from the interior of the electrical distribution panel enclosure 10.

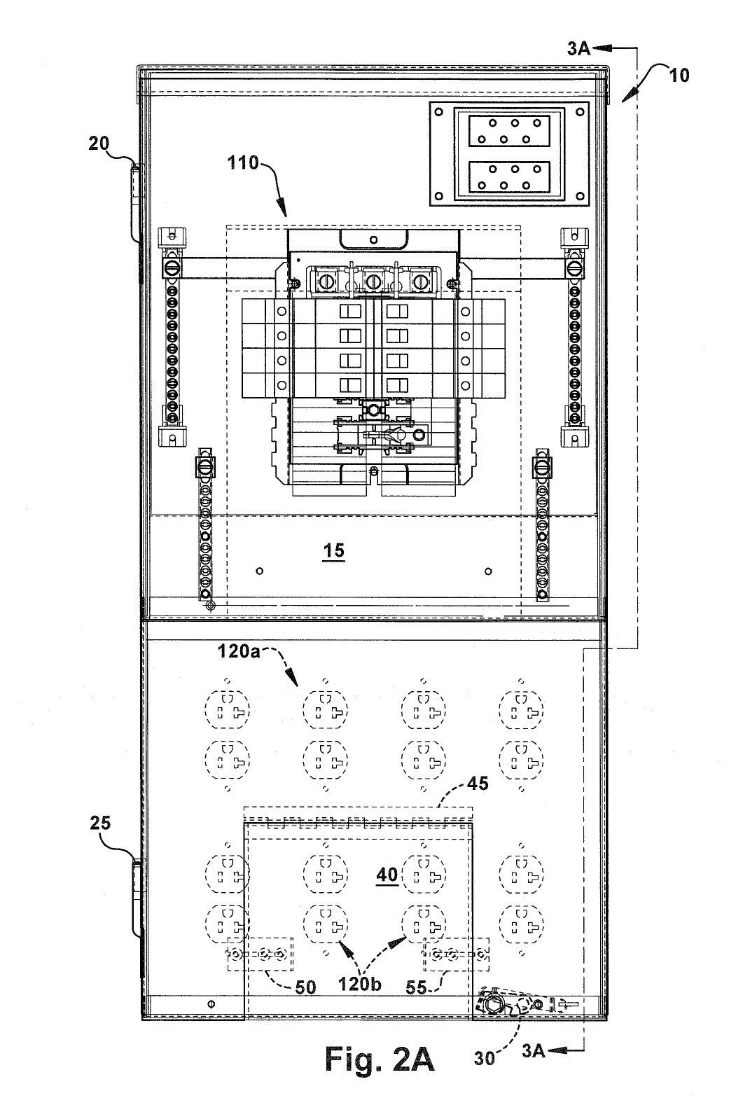

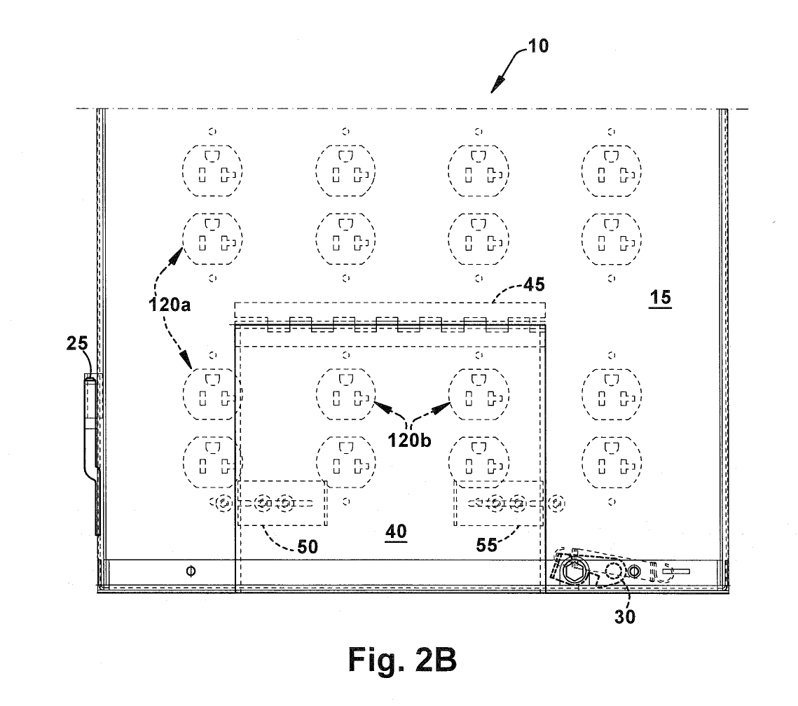

Referring to FIG. 2A, the electrical distribution panel enclosure 10 of FIG. 1 is shown with the front door 15 in phantom to show the interior of the enclosure 10. The enclosure 10 houses a plurality of electrical devices. In the embodiment illustrated, the plurality of electrical devices includes circuit breakers 110 and electrical receptacles 120a and 120b.

In the example embodiment illustrated in FIG. 2A, the circuit breakers 110 and electrical receptacles 120a are placed in the enclosure 10 in a high position relative to the access door 40. The electrical receptacles 120b are placed on the same level as the access door 40. When the front door 15 is in the closed position and the access door 40 is open, access is provided to selected electrical receptacles 120b. However, the circuit breakers 110 and electrical receptacles 120a are not accessible when the access door 40 is open and the front door 15 is closed.

FIG. 2B illustrates a subset of the plurality of electrical devices is accessible by way of the access door 40. The subset of electrical devices to which access is provided may be the electrical devices to which access may be desirable. Meanwhile, access to the electrical distribution panel enclosure 10 as a whole remains restricted. Electrical devices that should be handled by a professional, may cause disruption in power, or are deemed not for public use are secured by the front door 15. Therefore, the ability to secure the front door 15 (in phantom) while providing access to a selected subset of electrical devices allows tiered usage of the electrical distribution panel enclosure 10.

FIG. 2B shows the latching mechanisms 50 and 55 in an unlatched position. In the unlatched position, the access door 40 may be opened. Latching mechanisms 50 and 55 are interior to the enclosure 10. Therefore, to operate the latching mechanisms 50 and 55, an individual must have access to the enclosure 10 through the front door 15. If latching mechanisms 50 and 55 are engaged and the access door 40 is secured, and the access door 40 cannot be opened from the exterior of the enclosure 10.

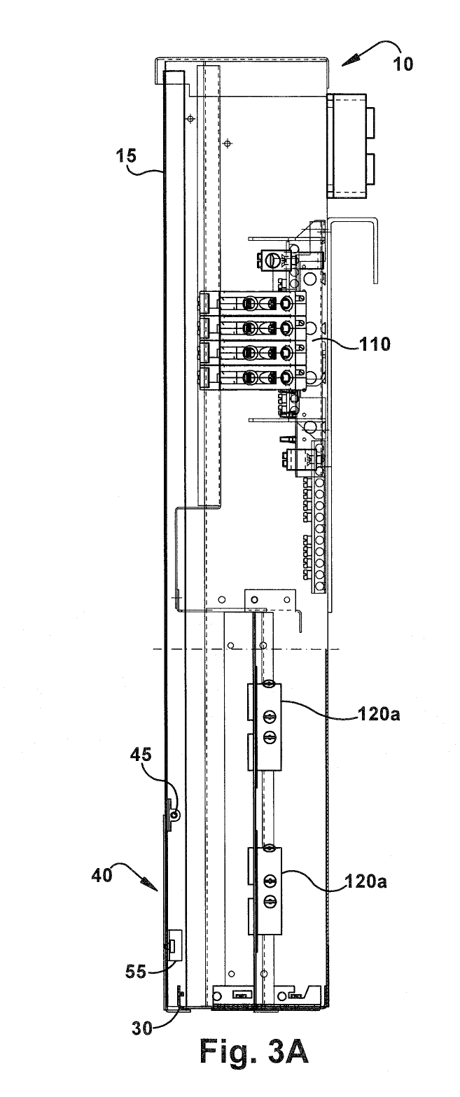

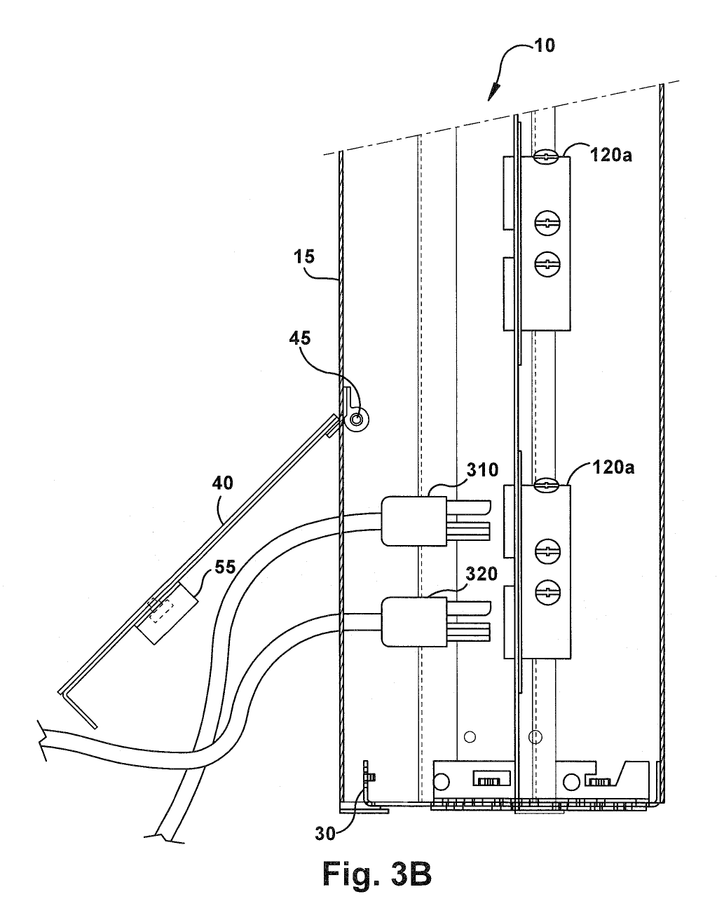

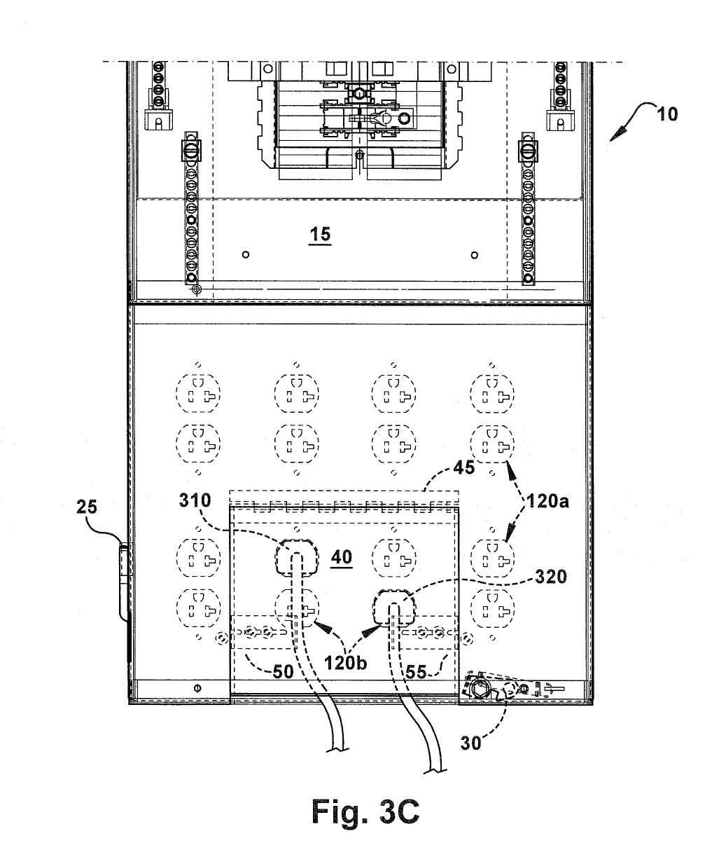

FIG. 3A is a side view of the electrical distribution panel enclosure 10 of FIG. 1. In FIG. 3A, the access door 40 is in the closed position. The access door 40 is attached to the front door 15 by access door hinge 45. The access door 40 can be secured to the front door 15 with latching mechanism 55. The front door 15 can be secured to the enclosure 10 with fastening mechanism 30. Electrical devices 110, 120a, and 120b are housed by the enclosure 10.

If it is determined that access to all of the devices in the electrical distribution panel enclosure 10 should be prevented, the front door 15 and the access door 40 may be secured. This would completely prevent access to the interior of electrical distribution panel enclosure 10. If access to a subset of a plurality of electrical devices is deemed appropriate, the front door 15 may be secured and the access door 40 may be unsecured.

FIG. 3B is a side view of the electrical distribution panel enclosure 10 of FIG. 1 showing the access door 40 in use. The front door 15 is shown in the closed position. The access door 40 is shown in the open position. The access door 40 provides access to selected electrical receptacles 120b. Electrical plugs 310 and 320 can be plugged in to electrical receptacles 120b. An access door hinge 45 allows the access door 40 to open. The access door hinge 45 may be a piano hinge.

The access door 40 allows the cable end of the electrical plugs 310 and 320 to exit the electrical distribution panel enclosure 10. In one embodiment, the access door 40 may rest on the electrical plugs 310 or 320. Alternatively, the access door hinge 45 may support the access door 40 at a position perpendicular to the front door 15. The access door 40 may be positioned at a desired angle with respect to the front door 15 with the application of downward pressure.

FIG. 3C is a front view of the electrical distribution panel enclosure 10 of FIG. 1 showing the access door 40 in use. The electrical plugs 310 and 320 are shown plugged into two of the selected electrical receptacles 120b. Access can be provided to any portion of the electrical devices. Access is determined by the size and location of the access opening. As shown, access is provided to a selected subset of electrical receptacles 120b.

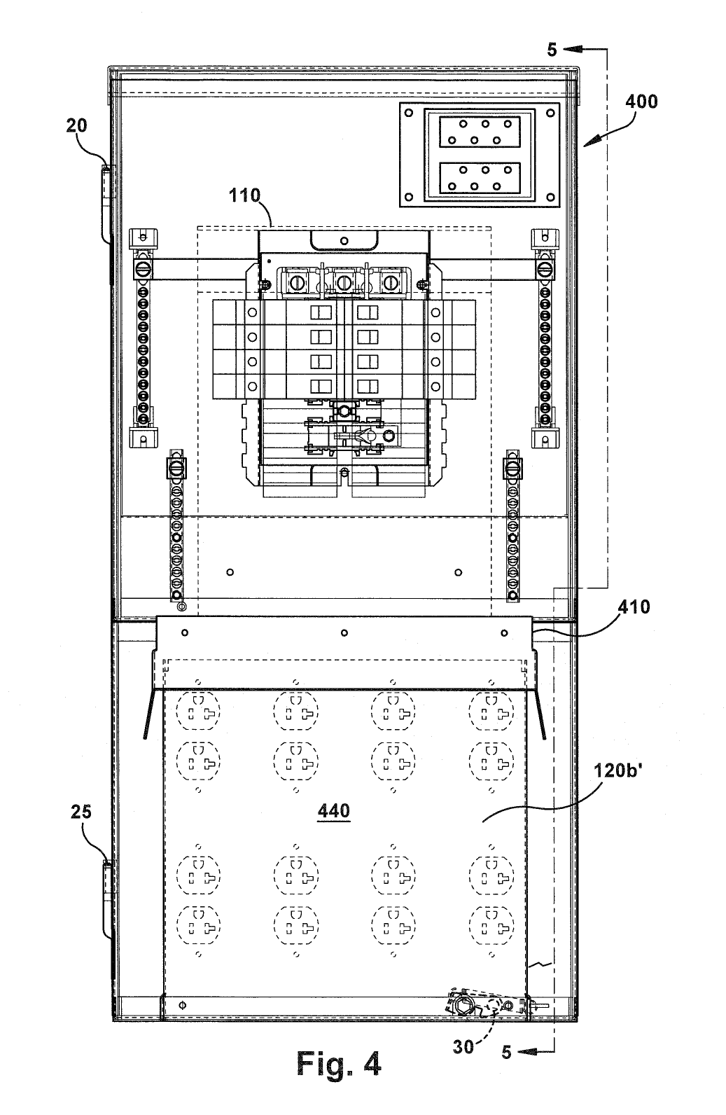

FIG. 4 is a front view of an electrical distribution panel enclosure 400 including an access door 440 covering a larger access opening than the access opening shown in FIG. 1. In this embodiment access to all receptacles 120b′ is provided. The access door 440 has a hood 410 that extends from the front door 15 at an angle. The hood 410 may be molded as a portion of the front door 15. Alternatively, the hood 410 may be secured to the front door 15 with fasteners (e.g., adhesive, screws, pins).

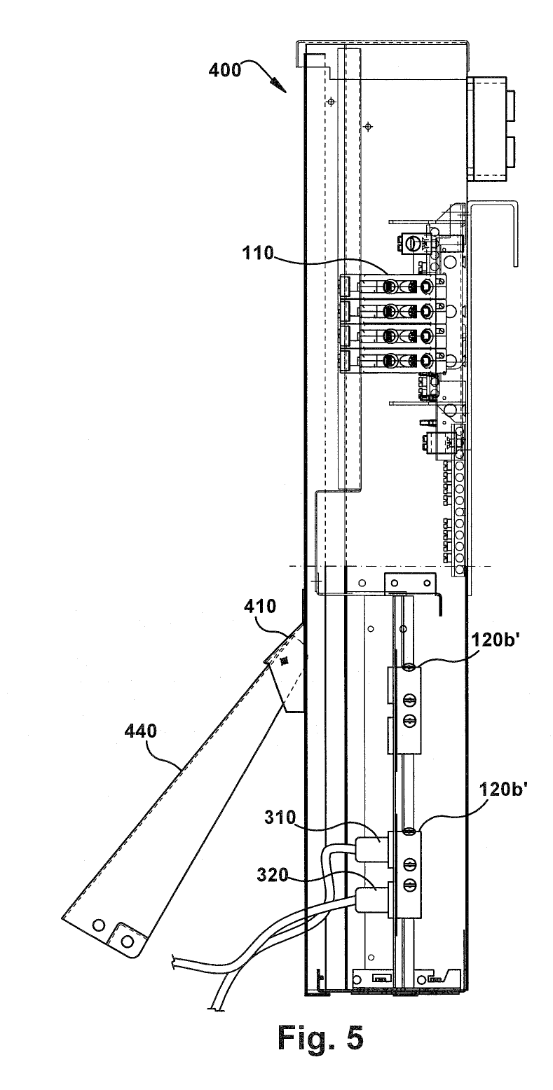

FIG. 5 illustrates the electrical distribution panel enclosure 400 shown with the access door 440 and a hood 410. The hood 410 is positioned over the access door 440 to protect the plurality of electrical devices housed in the electrical distribution panel enclosure 400. The access door 440 may remain open to allow access to the subset of electrical devices while the hood 410 protects the electrical devices within the enclosure 400.

To the extent that the term “includes” or “including” is employed in the detailed description or the claims, it is intended to be inclusive in a manner similar to the term “comprising” as that term is interpreted when employed as a transitional word in a claim.

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Therefore, the invention is not limited to the specific details, the representative apparatus, and illustrative examples shown and described. Thus, this application is intended to embrace alterations, modifications, and variations that fall within the scope of the appended claims.

What is claimed is:

1. An apparatus comprising:
an electrical distribution panel enclosure including a rear wall having side walls, a top wall, and a bottom wall extending therefrom defining a front opening to an interior of the enclosure, where the enclosure is configured to house a plurality of electrical devices;
a front door coupled to the enclosure and covering the front opening, the front door including an access opening that provides access to less than all of the plurality of the electrical devices when the front door is closed;
an access door coupled to the front door and covering the access opening, the access door being moveable with respect to the front door to provide access to less than all of the plurality of electrical devices.

2. The apparatus of claim 1, where the access door is securable from the interior of the enclosure.

3. The apparatus of claim 1, where the access door is independently operable with respect to the front door.

4. The apparatus of claim 1, where the access door is securable with a latching mechanism positioned on the interior face of the front door.

5. The apparatus of claim 1, where the access door is attached to the front door at a top of the access opening.

6. The apparatus of claim 1, where the access door is attached to the front door with at least one hinge.

7. The apparatus of claim 1, where the front door is attached at a side wall of the enclosure.

8. The apparatus of claim 1, where the front door is attached to the enclosure with at least one hinge.

9. The apparatus of claim 1, where the plurality of electrical devices includes at least one of electrical receptacles, circuit breakers, Category-5 jacks, cable jacks, phone jacks, and electrical switches.

10. The apparatus of claim 1, where the plurality of electrical devices includes circuit breakers and electrical receptacles and where the access door provides access to a selected subset of the electrical receptacles.

11. The apparatus of claim 1, where the access door includes a hood configured to divert water from the interior of the enclosure.

12. An apparatus comprising:
a front door that includes an interior face and an exterior face that is configured to be coupled to an electrical distribution panel enclosure to provide access to a plurality of electrical devices within the electrical distribution panel enclosure, where the front door includes a cut-out; and
an access door that is positioned to cover the cut-out, where the secondary access door is configured to be independently operable with respect to the front door and to provide access to less than all of the electrical devices in the plurality of electrical devices.

13. The apparatus of claim 12, where the access door is securable to the interior face of the front door.

14. The apparatus of claim 12, where the access door is securable with a latching mechanism positioned on the interior face of the front door.

15. The apparatus of claim 12, where the access door is attached to a top of the cut-out.

16. The apparatus of claim 12, where the access door is attached to the front door with at least one hinge.

17. The apparatus of claim 16, where the at least one hinge is a piano hinge.

18. The apparatus of claim 12, where the plurality of electrical devices includes at least one of electrical receptacles, circuit breakers, Category-5 jacks, cable jacks, phone jacks, and electrical switches.

19. The apparatus of claim 12, where the plurality of electrical devices includes circuit breakers and electrical receptacles and where the access door provides access to a selected subset of the electrical receptacles.

20. The apparatus of claim 12, where the access door includes a hood configured to divert water from the interior face of the front door.
